(19) United States
(12) Patent Application Publication
(10) Pub. No.: US 2025/0157227 A1
(43) Pub. Date: May 15, 2025

(54) DETERMINING LANE INFORMATION

(71) Applicant: QUALCOMM Incorporated, San Diego, CA (US)

(72) Inventors: Tobias HAMMARLING, Vreta Kloster (SE); Jonas Bengt Emil Allan JOSEFSSON, Linköping (SE); Mats FAELLMAN, Linköping (SE); Simon ASTROEM, Linköping (SE); Andreas LIDSTROEM, Linköping (SE); Johan LIND, Linköping (SE)

(21) Appl. No.: 18/508,001

(22) Filed: Nov. 13, 2023

(51) Int. Cl. G06V 20/56; G06T 7/13; G06T 7/246; G06T 7/73; G06V 10/82; G06V 20/58

(52) U.S. Cl. CPC G06V 20/588; G06T 7/13; G06T 7/248; G06T 7/74; G06V 10/82; G06V 20/582; G06T 2207/10016; G06T 2207/20081; G06T 2207/20084; G06T 2207/30256

(57) ABSTRACT

Systems and techniques are described herein for determining lane information. For instance, a method for determining lane information is provided. The method may include obtaining an image representative of one or more lanes of a road and an object, wherein the object is adjacent to the road; and determining coordinates of object-to-lane association points of at least one lane of the one or more lanes of the road, wherein the coordinates are associated with the object

### TECHNICAL FIELD

The present disclosure generally relates to determining lane information. For example, aspects of the present disclosure include systems and techniques for determining relationships between signs adjacent to the road and lanes of the road.

### BACKGROUND

An object detector may detect objects in images. For each detected object, the object detector may generate a bounding box comprised of image coordinates that relate to the respective detected object. For example, a bounding box may define a portion of the image that represents an object. For instance, the bounding box may define pixels of the image that represent the object.

A lane detector may detect lanes in image of a road. The lane detector may generate lane boundaries that may be, or may include, image coordinates that relate to lane lines. For example, in the physical world, lane lines may denote lanes of a road. A lane detector may define lane boundaries that may define pixels of the image that represent the lane lines. The lane boundaries may be used to define portions of an image that represent various lanes of the road. For example, a lane detector may receive an image and identify a first portion of the image (e.g., between two lane boundaries) that represents a first lane (e.g., an ego lane), a second portion of the image (e.g., between two lane boundaries) that represents a second lane (e.g., a lane left of the ego lane), and a third portion of the image (e.g., between two lane boundaries) that represents a third lane (e.g., a lane right of the ego lane).

Using bounding boxes (e.g., from an object detector) and lane boundaries (e.g., from a lane detector) it may be possible to determine which lane vehicles are in. For example, if a vehicle is traveling on a road that includes several lanes, and capturing images of other vehicles on the road, a computing system of the vehicle may determine which lane the other vehicles are in (e.g., by comparing the bounding boxes of the other vehicles with the lane boundaries).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for determining lane information. According to at least one example, a method is provided for determining lane information. The method includes: obtaining an image representative of one or more lanes of a road and an object, wherein the object is adjacent to the road; and determining coordinates of object-to-lane association points of at least one lane of the one or more lanes of the road, wherein the coordinates are associated with the object.

In another example, an apparatus for determining lane information is provided that includes at least one memory and at least one processor (e.g., configured in circuitry) coupled to the at least one memory. The at least one processor configured to: obtain an image representative of one or more lanes of a road and an object, wherein the object is adjacent to the road; and determine coordinates of object-to-lane association points of at least one lane of the one or more lanes of the road, wherein the coordinates are associated with the object.

In another example, a non-transitory computer-readable medium is provided that has stored thereon instructions that, when executed by one or more processors, cause the one or more processors to: obtain an image representative of one or more lanes of a road and an object, wherein the object is adjacent to the road; and determine coordinates of object-to-lane association points of at least one lane of the one or more lanes of the road, wherein the coordinates are associated with the object.

In another example, an apparatus for determining lane information is provided. The apparatus includes: means for obtaining an image representative of one or more lanes of a road and an object, wherein the object is adjacent to the road; and means for determining coordinates of object-to-lane association points of at least one lane of the one or more lanes of the road, wherein the coordinates are associated with the object.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system for determining lane information, according to various aspects of the present disclosure;

FIG. 2 includes an example image of three lanes of a road and two objects adjacent to the road to illustrate concepts according to various aspects of the present disclosure;

FIG. 3 includes an example bird's-eye-view representation of three lanes of a road and two objects adjacent to the road to illustrate concepts according to various aspects of the present disclosure.

FIG. 4 includes an example image of three lanes of a road and five objects adjacent to the road to illustrate concepts according to various aspects of the present disclosure;

FIG. 5 includes an example bird's-eye-view representation of three lanes of a road and five objects adjacent to the road to illustrate concepts according to various aspects of the present disclosure;

FIG. 6 includes an example image of two lanes of a road and one object adjacent to the road to illustrate concepts according to various aspects of the present disclosure;

FIG. 7 is a block diagram illustrating another example system for determining lane information, according to various aspects of the present disclosure;

FIG. 8 is a block diagram illustrating yet another example system for determining lane information, according to various aspects of the present disclosure.

FIG. 9 is a block diagram illustrating yet another example system for determining lane information, according to various aspects of the present disclosure.

FIG. 10 is a flow diagram illustrating another example process for determining lane information, in accordance with aspects of the present disclosure;

FIG. 11 is a block diagram illustrating an example of a deep learning neural network that can be used to implement a perception module and/or one or more validation modules, according to some aspects of the disclosed technology;

FIG. 12 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As described above, it is possible to use bounding boxes (e.g., from an object detector) and lane boundaries (e.g., from a lane detector) to determine which lane vehicles are in. However, such techniques may not be capable of associating objects adjacent to a road with lanes of the road. For example, a sign beside a road, or above a road, may provide information for driving on the road (e.g., instructions, limits, and/or navigational information). However, a bounding box of such a sign (e.g., determined by an object detector) may not be between lane boundaries (e.g., determined by a lane detector). For example, a bounding box for a sign that is beside the road may be outside all lane boundaries. As another example, a bounding box for a sign that is above a road, but not aligned to a lane, may not be between lane boundaries. Thus the techniques used to associate vehicles in lanes with the lanes may not be able to associate signs with lanes. Further, in some cases, such a sign may provide information relative to some lanes of the road and not others. For example, on a multi-lane highway, a sign above the highway may indicate that certain lanes are bound for certain destinations (e.g., at an upcoming division of the lanes). Accordingly, it may be important to be able to associate objects (e.g., signs) adjacent to lanes (e.g., beside or above the road) with lanes to which they pertain.

Systems, apparatuses, methods (also referred to as processes), and computer-readable media (collectively referred to herein as “systems and techniques”) are described herein for determining lane information. For example, the systems and techniques may identify objects (e.g., signs) in an image and determine to which lanes of a road the objects pertain. For instance, the systems and techniques may obtain an image representative of a road (e.g., a multi-lane road) and an object adjacent to the road. The object may be a sign on the side of the road or above the road. The systems and techniques may determine, for the object, coordinates of object-to-lane association points of at least one lane of the road. In some aspects, the coordinates may be, or may include, image coordinates (e.g., indicative of pixel positions). In some aspects, the coordinates may be, or may include, three-dimensional coordinates. The three-dimensional coordinates may be relative to a camera which captured the image. Alternatively, the three-dimensional coordinates may be relative to a reference coordinate system (e.g., latitude and longitude). The coordinates may be associated with the object. For example, for a stop sign on the side of the road, the systems and techniques may determine object-to-lane association points indicative of lane edges of the lanes of the road to which the stop sign pertains.

The systems and techniques may use a trained machine-learning model (e.g., a trained neural network) to determine the coordinates. For example, a machine-learning model may be trained (e.g., through a backpropagation training process) on a corpus of training data including images of roads and signs annotated with coordinates (e.g., image coordinates or three-dimensional coordinates) representing lane edges that are related to the signs. In more detail, the machine-learning model may be provided with an image of a road and a sign. The machine-learning model may predict coordinates of lane edges related to the sign. The predicted coordinates may be compared with coordinates in annotations of the image and a difference (e.g., an error) between the predicted coordinates and the coordinates of the annotations may be determined. Parameters (e.g., weights) of the machine-learning model may be adjusted to minimize the error in future iterations and the process may be repeated a number of times using various images and annotations from the corpus of training data. Once trained, the machine-learning model may be provided with an image (e.g., not part of the corpus of training data) and the machine-learning model may generate coordinates based on the image.

In some aspects, the systems and techniques (or an autonomous or semi-autonomous driving system using the systems and techniques) may use the coordinates to control a vehicle. For example, in some aspects, the systems and techniques may model the coordinates as points in a three-dimensional (or two-dimensional) map of an environment of the vehicle and control the vehicle based on information provided by the signs as it pertains to the lanes. In some aspects, the systems and techniques may use the coordinates to obtain information (e.g., associations between signs and lanes). Such information may be provided to a driver or stored (e.g., in a map). For example, the coordinates can be used to determine if a speed limit is relevant for the lane in which an ego vehicle is driving. In a non-autonomous vehicle this information (current or upcoming speed limits) can be provided as information to the driver and/or a warning can be raised if the vehicle is driving too fast. Additionally or alternatively, the coordinates may be used to generate warnings, for example, for stop signs, crosswalks etc. For example, the coordinates may be used to determine if the signs (e.g., stop signs or crosswalk signs) are relevant for ego vehicle.

Additionally or alternatively, in some aspects, the systems and techniques may track the coordinates across multiple images, for example to improve the positions of the coordinates by updating the coordinates based on the tracking. Additionally or alternatively, the systems and techniques may track points based on the coordinates (e.g., points of a map used by an autonomous or semi-autonomous driving system to control a vehicle) over time (e.g., based on several images captured over the time), for example to improve the position of the points in the map by updating the points based on the tracking.

It is important for autonomous/semi-autonomous driving systems (e.g., of autonomous vehicles) to follow posted instructions and limits (e.g., speed limits and stop signs). Also, it may be important for autonomous vehicles to interpret navigational instructions from signs. Signs may include instructions that may not be reflected on a map (e.g., detours or temporary speed limits in construction zones). Thus, it may be important for autonomous/semi-autonomous driving systems to be able to derive information from signs. Further, it may be important for autonomous/semi-autonomous driving systems to correctly associate objects (e.g., signs) with lanes to which the objects relate. These capabilities may become even more important for higher levels of autonomy, such as autonomy levels 3 and higher. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions own. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action. Thus, autonomous/semi-autonomous driving systems are an example of where systems and techniques may be employed. Also, the systems and techniques may be employed in non-autonomous (e.g., human controlled) vehicles. For example, the systems and techniques may provide information regarding signs and lanes to a driver. For example, the systems and techniques may present information related to signs to a driver based on the signs pertaining to a lane in which the driver is driving.

Various aspects of the application will be described with respect to the figures below.

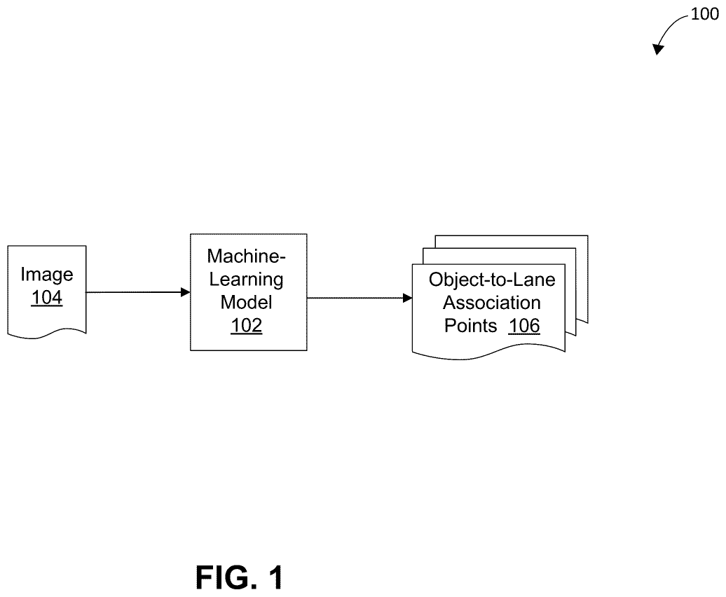

FIG. 1 is a block diagram illustrating an example system 100 for determining lane information, according to various aspects of the present disclosure. System 100 includes a machine-learning model 102 that may receive an image 104 as an input and generate object-to-lane association points 106 as an output. System 100 may be included in an autonomous or semi-autonomous driving system. Object-to-lane association points 106 may be used by the autonomous or semi-autonomous driving system in controlling a vehicle (e.g., based on instruction, restrictions, and/or navigational information provided by objects, such as signs, in image 104). Additionally or alternatively, object-to-lane association points 106 may be used to provide information to a driver.

Image 104 may be an image of a road and one or more objects adjacent to the road. The road may include multiple lanes. The multiple lanes may include multiple lanes for travelling in the same direction (e.g., a multi-lane highway) or multiple intersecting lanes. The one or more objects may include objects beside the road and/or objects above the road. Image 104 may be captured by a camera of a vehicle.

Object-to-lane association points 106 may be, or main include coordinates of edges of lanes. In some cases, object-to-lane association points 106 may be, or may include, image coordinates, for example, pixel coordinates describing where the lane edges appear in image 104. In other cases, object-to-lane association points 106 may be, or may include, three-dimensional coordinates describing lane edges in three dimensions. The three-dimensional coordinates may be relative to camera that captured image 104 (e.g., a pitch, a yaw and a distance, or meters in three dimensions, such as x, y, and z relative to the camera). Additionally or alternatively, the three-dimensional coordinates may be relative to a reference coordinate system (e.g., latitude, longitude, and altitude). Object-to-lane association points 106 may be associated with objects in image 104. For example, object-to-lane association points 106 may include two or more coordinates for each object (e.g., sign) in image 104. For example, image 104 may include a representation of a sign beside a lane of a multi-lane road. Object-to-lane association points 106 may be coordinates corresponding to edges of the lane to which the sign pertains.

Machine-learning model 102 may be, or may include, a trained neural network (e.g., a transformer). Machine-learning model 102 may be trained (e.g., through a backpropagation training process) to generate coordinates (e.g., image coordinates or three-dimensional coordinates) of lane edges related to objects based on images. For example, prior to deployment in system 100, machine-learning model 102 may be trained through an iterative training process involving providing machine-learning model 102 with a number of images of roads and signs of a corpus of training data. During the training process, machine-learning model 102 may predict coordinates of lane edges related to objects in the images. The predicted coordinates may be compared with coordinates of annotations of the images (the annotations may be part of the corpus of training data) and errors between the predicted coordinates and the coordinates of the annotations may be determined. Parameters (e.g., weights) of machine-learning model 102 may be adjusted such that in future iterations of the iterative training process, machine-learning model 102 may more accurately determine the coordinates. Once trained, machine-learning model 102 may be deployed in system 100 and may determine object-to-lane association points 106 based on image 104.

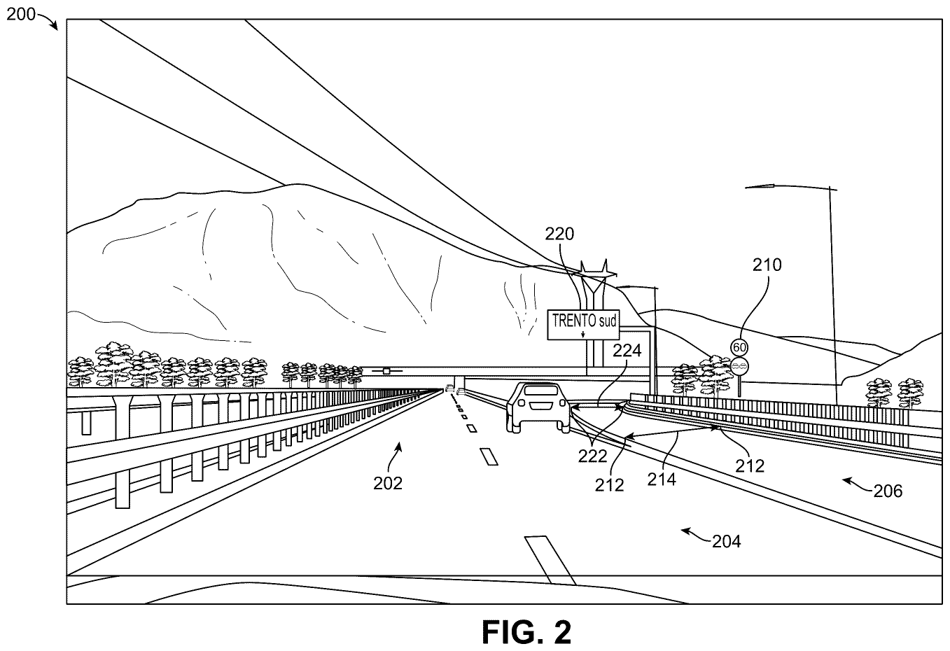

FIG. 2 includes an example image 200 of three lanes of a road and two objects adjacent to the road to illustrate concepts according to various aspects of the present disclosure. Image 200 includes a representation of a road (e.g., pixels representative of the road) including lane 202, lane 204, and lane 206. In image 200, all of lane 202, lane 204, and lane 206 are intended for travel in the same direction (e.g., into the plane of image 200). Image 200 may be an example of image 104 of FIG. 1.

Image 200 includes a representation of a sign 210 (e.g., pixels representative of the sign) and a sign 220 (e.g., pixels representative of the sign). Sign 210 and sign 220 are examples of objects. Sign 210 and sign 220 are adjacent to the road. For example, sign 210 is beside lane 206 and sign 220 is above lane 206. According to the example of image 200, both sign 210 and sign 220 pertain to lane 206 and not to lane 202 or lane 204. For example, sign 210 may indicate that while traveling in lane 206, the speed limit is 60 kilometers per hour (km/h) and sign 220 may indicate navigational information associated with sign 220 (e.g., sign 220 may indicate that lane 206 goes toward Trento).

Also illustrated in image 200 are line 214 and line 224. Line 214 and line 224 may be overlaid onto an image as captured by a camera. Line 214 and line 224 may be determined by systems and techniques of the present disclosure (e.g., by system 100 of FIG. 1). Line 214 may be defined by object-to-lane association points 212 and line 224 may be defined by object-to-lane association points 222. As such, the systems and techniques may determine object-to-lane association points 212 and object-to-lane association points 222 (e.g., additionally or alternatively to determining line 214 and line 224). Object-to-lane association points 212 and object-to-lane association points 222 may be examples of object-to-lane association points 106 of FIG. 1. Object-to-lane association points 212 and object-to-lane association points 222 may be determined, for example, by a machine-learning model 102 of FIG. 1.

The systems and techniques (e.g., system 100 of FIG. 1) may determine line 214 (or object-to-lane association points 212) based on, and associated with, sign 210. For example, the systems and techniques may determine coordinates of object-to-lane association points 212 of lane 206. The systems and techniques may determine the coordinates of object-to-lane association points 212 based on sign 210. Further the systems and techniques may associate the coordinates of object-to-lane association points 212 with sign 210. For example, the systems and techniques may detect sign 210 (or receive an indication of sign 210, such as a bounding box). The systems and techniques may determine coordinates of object-to-lane association points 212 and associate the coordinates of object-to-lane association points 212 with sign 210. By associating object-to-lane association points 212 with sign 210, the systems and techniques may determine, or indicate, sign 210 pertains to lane 206. For example, the systems and techniques may determine that sign 210 provides instructions, restrictions, or navigational information relative to lane 206.

Line 214 may be at the level of the road in image 200. For example, despite sign 210 being above the level of the road at the depth of sign 210 in image 200, and/or despite sign 210 being above a horizon line in image 200, line 214 may be at the level of the road in image 200 at the depth of sign 210. Further, line 214 may be laterally offset from sign 210. For example, line 214 is to the left of sign 210 in image 200. Further, line 214 may be perpendicular to a direction of travel of lane 206.

Similarly, the systems and techniques (e.g., system 100 of FIG. 1) may determine line 224 (or object-to-lane association points 222) based on, associated with, sign 220. Line 224 may be at the level of the road in image 200. For example, despite sign 220 being above the road in image 200, line 224 may be at the level of the road in image 200 at the depth of sign 220. Further, line 224 may be perpendicular to a direction of travel of lane 206.

Object-to-lane association points (e.g., object-to-lane association points 106 of FIG. 1, object-to-lane association points 212 and/or object-to-lane association points 222) may accurately represent edges of lanes according to real-world conditions. Object-to-lane association points may represent a diverse range of traffic situations and/or lane configurations. The task of generating object-to-lane association points may be learned by a machine-learning model such that the machine-learning model may be able to repeat the task on new images.

In some aspects, the systems and techniques (e.g., system 100 of FIG. 1) may track coordinates (e.g., object-to-lane association points 212 and/or object-to-lane association points 222 of image 200) across multiple images and/or in three-dimensions (e.g., in a three-dimensional model of the environment of the systems and techniques). For example, a camera which captured image 200 may capture additional images (e.g., multiple images each second). The systems and techniques may generate coordinates (image coordinates and/or three-dimensional coordinates) of object-to-lane association points based on each of the images and track the position of the coordinates across the multiple images and/or across time through three dimensions. Through tracking the coordinates, the systems and techniques may update the coordinates (e.g., using a Kalman filtering technique) and thereby improve the coordinates.

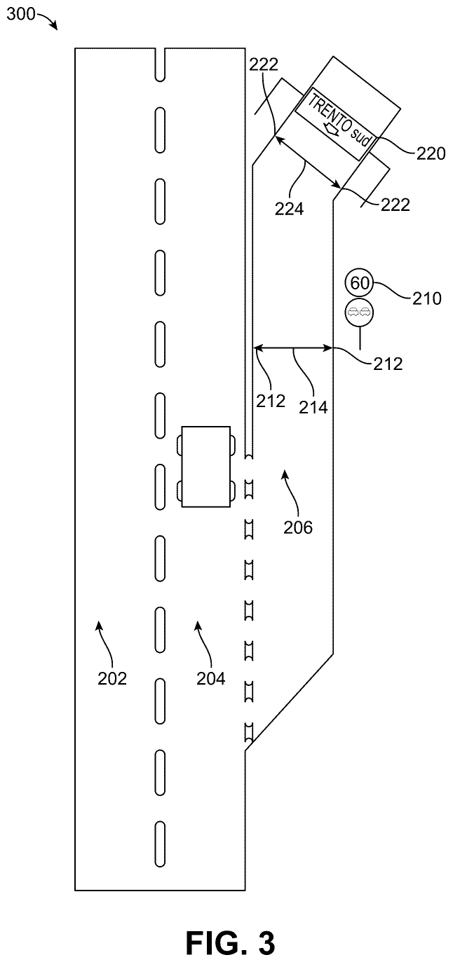

FIG. 3 includes an example bird's-eye-view representation 300 of three lanes of a road and two objects adjacent to the road to illustrate concepts according to various aspects of the present disclosure. Bird's-eye-view representation 300 includes a representation of a road (e.g., an example two-dimensional map representative of the road). An autonomous or semi-autonomous driving system may use a map such as the one illustrated by bird's-eye-view representation 300 to control an autonomous (or semi-autonomous vehicle). For example, an autonomous or semi-autonomous driving system may make determinations about changing lanes, accelerating, decelerating, and/or turning, based on a map such as the one represented by bird's-eye-view representation 300. For descriptive purposes, bird's-eye-view representation 300 corresponds to the scene captured by image 200 of FIG. 2.

The road of bird's-eye-view representation 300 includes lane 202, lane 204, and lane 206. Further, bird's-eye-view representation 300 includes sign 210 and sign 220. The systems and techniques (e.g., system 100 of FIG. 1) may generate line 214 and line 224 (and/or object-to-lane association points 212 and object-to-lane association points 222) based on an image (e.g., image 200). The systems and techniques may include representations of line 214 and line 224 (and/or object-to-lane association points 212 and object-to-lane association points 222) in a map (e.g., as represented by bird's-eye-view representation 300). In other words, in addition to generating line 214 and line 224 (and/or object-to-lane association points 212 and object-to-lane association points 222) in an image plane (e.g., as image coordinates), the systems and techniques may model line 214 and line 224 (and/or object-to-lane association points 212 and object-to-lane association points 222) in a two-dimensional map and/or in a three-dimensional map that may be used by an autonomous or semi-autonomous driving system to control a vehicle and/or provide information to a driver. For example, the systems and techniques may project line 214 and line 224 (and/or object-to-lane association points 212 and object-to-lane association points 222) from an image plane into a three-dimensional model of the environment of a vehicle which captured image 200, for example, as represented by bird's-eye-view representation 300.

In some aspects, the systems and techniques (e.g., system 100 of FIG. 1) may track object-to-lane association points 212 and object-to-lane association points 222 in the three-dimensional model over time (e.g., based on receiving determining multiple coordinates based on multiple respective images). For example, a camera which capture image 200 may capture additional images (e.g., multiple images each second). The systems and techniques may generate coordinates (e.g., three-dimensional coordinates) of the object-to-lane association points based on each of the images and model the coordinates as points in the three-dimensional model. The systems and techniques may track the coordinates of the object-to-lane association points over time. Through tracking the object-to-lane association points, the systems and techniques may update the object-to-lane association points (e.g., using a Kalman filtering technique) and thereby improve the positions of the object-to-lane association points.

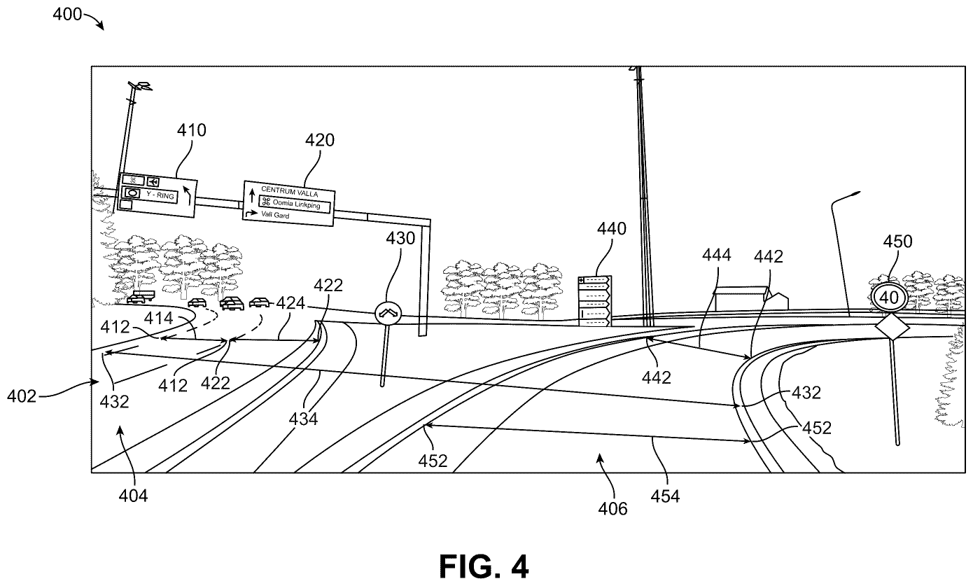

FIG. 4 includes an example image 400 of three lanes of a road and five objects adjacent to the road to illustrate concepts according to various aspects of the present disclosure. Image 400 includes a representation of a road (e.g., pixels representative of the road) including lane 402, lane 404, and lane 406. In a lower portion of image 400, all of lane 402, lane 404, and lane 406 are intended for travel in the same direction (e.g., into the plane of image 400) but higher up in image 400, lane 402 and lane 404 split from lane 406 and head in a different direction than lane 406. Image 400 may be an example of image 104 of FIG. 1.

Image 400 includes representations of sign 410 above lane 402, sign 420 above lane 404, sign 430 beside lane 404 and lane 406, sign 440 beside lane 406, and sign 450 beside lane 406. The systems and techniques (e.g., system 100 of FIG. 1) may determine object-to-lane association points 412 and/or line 414 based on sign 410, object-to-lane association points 422 and/or line 424 based on sign 420, object-to-lane association points 432 and/or line 434 based on sign 430, object-to-lane association points 442 and/or line 444 based on sign 440, and object-to-lane association points 452 and/or line 454 based on sign 450. Object-to-lane association points 412, object-to-lane association points 422, object-to-lane association points 432, object-to-lane association points 442, and object-to-lane association points 452 may be examples of object-to-lane association points 106 of FIG. 1.

The systems and techniques (e.g., system 100 of FIG. 1) may receive image 400 as an input and may determine object-to-lane association points 412, object-to-lane association points 422, object-to-lane association points 432, object-to-lane association points 442, and/or object-to-lane association points 452 using a trained machine-learning model (e.g., machine-learning model 102 of FIG. 1). In some cases, the systems and techniques may detect sign 410, sign 420, sign 430, sign 440, and/or sign 450, for example, the systems and techniques may determine bounding boxes indicative of pixels representative of each of sign 410, sign 420, sign 430, sign 440, and/or sign 450 (e.g., using an object detector). Additionally or alternatively, the systems and techniques may receive an indication of bounding boxes from another source (e.g., from an object detector external to the systems and techniques). In other cases, the systems and techniques may not explicitly use bounding boxes but may rather determine object-to-lane association points 412, object-to-lane association points 422, object-to-lane association points 432, object-to-lane association points 442, and/or object-to-lane association points 452 based on image 400 without additional inputs.

Line 414 may be determined (e.g., by the systems and techniques, such as system 100 of FIG. 1) to be below sign 410 and laterally offset (based on the perspective of image 400) from sign 410. Further, line 414 may be determined to be associated with lane 402. Sign 410 may provide navigational information pertaining to lane 402. Line 424 may be determined (e.g., by the systems and techniques) to be below sign 420 and to be associated with lane 404. Sign 420 may provide navigational information pertaining to lane 404. Line 434 may be determined (e.g., by the systems and techniques) to be at a road level at the depth of sign 430. Line 434 may be determined to be associated with all of lane 402, lane 404, and lane 406. For example, the systems and techniques may determine that the information provided by sign 430 may pertain to all of lane 402, lane 404, and lane 406. Sign 430 may indicate a split between lane 402 and lane 404 and lane 406. Line 444 may be determined (e.g., by the systems and techniques) to be laterally offset from sign 440 and to be associated with lane 406. Sign 440 may provide navigational information pertaining to lane 406. Line 454 may be determined (e.g., by the systems and techniques) to be laterally offset from sign 450 and to be associated with lane 406. Sign 450 may indicate a speed limit pertaining to lane 406.

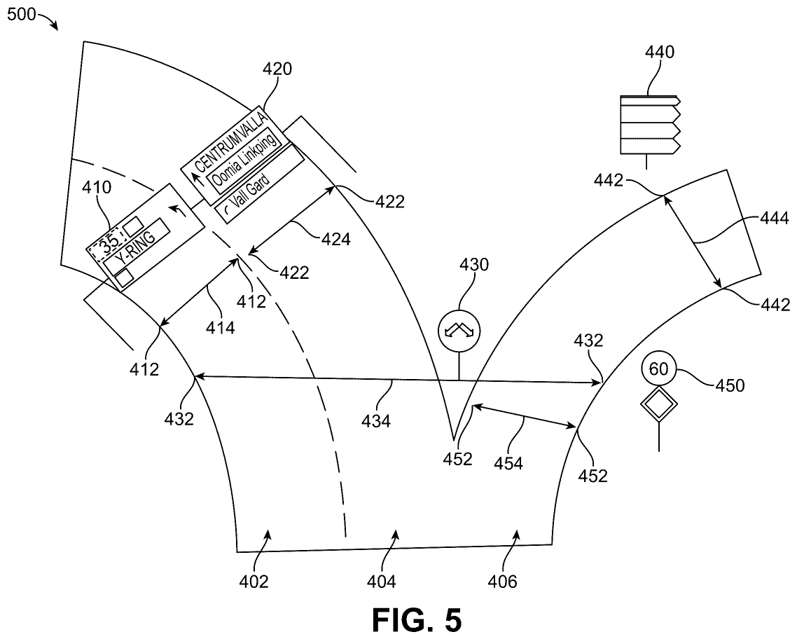

FIG. 5 includes an example bird's-eye-view representation 500 of three lanes of a road and five objects adjacent to the road to illustrate concepts according to various aspects of the present disclosure. For descriptive purposes, bird's-eye-view representation 500 corresponds to the scene captured by image 400 of FIG. 4.

The road of bird's-eye-view representation 500 includes lane 402, lane 404, and lane 406. Further, bird's-eye-view representation 500 includes sign 410, sign 420, sign 430, sign 440, and sign 450. The systems and techniques (e.g., system 100 of FIG. 1) may generate line 414, line 424, line 434, line 444, and line 454 based on an image (e.g., image 400). The systems and techniques may include representations of line 414, line 424, line 434, line 444, and line 454 in a map (e.g., as represented by bird's-eye-view representation 500). For example, the systems and techniques may project line 414, line 424, line 434, line 444, and line 454 from an image plane into a three-dimensional model of the environment of a vehicle which captured image 400, for example, as represented by bird's-eye-view representation 500.

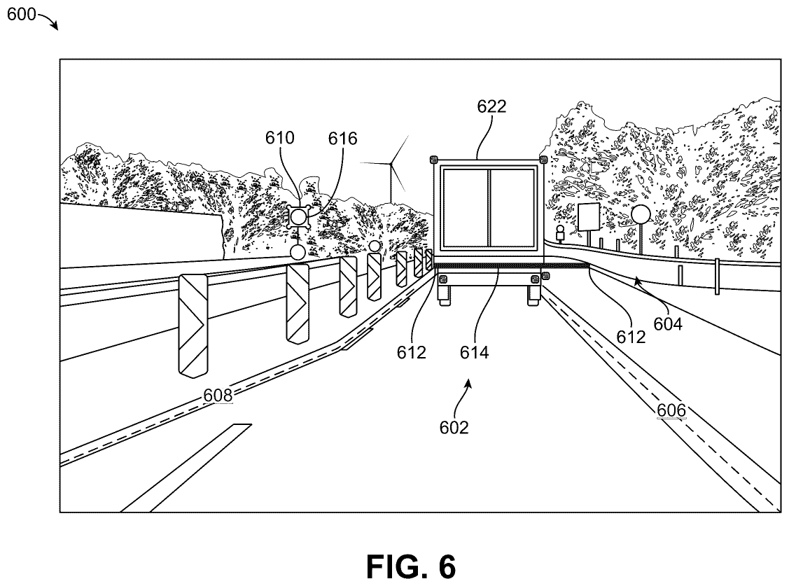

FIG. 6 includes an example image 600 of two lanes of a road and one object adjacent to the road to illustrate concepts according to various aspects of the present disclosure. Image 600 includes a representation of a road (e.g., pixels representative of the road) including lane 602 and lane 604. In image 600, both of lane 602 and lane 604 are intended for travel in the same direction (e.g., into the plane of image 600). Image 600 may be an example of image 104 of FIG. 1.

Image 600 includes representations of sign 610 beside lane 602. The systems and techniques (e.g., system 100 of FIG. 1) may determine object-to-lane association points 612 and/or line 614 based on sign 610. The systems and techniques may determine object-to-lane association points 612 and/or line 614 despite a portion of lane 602 being occluded from view by vehicle 622. For example, the systems and techniques may be capable of determining object-to-lane association points 612 and/or line 614 based on sign 610 even when a portion of lane boundaries and/or a portion of a lane is occluded in image 600. Object-to-lane association points 612 may be an example of object-to-lane association points 106 of FIG. 1.

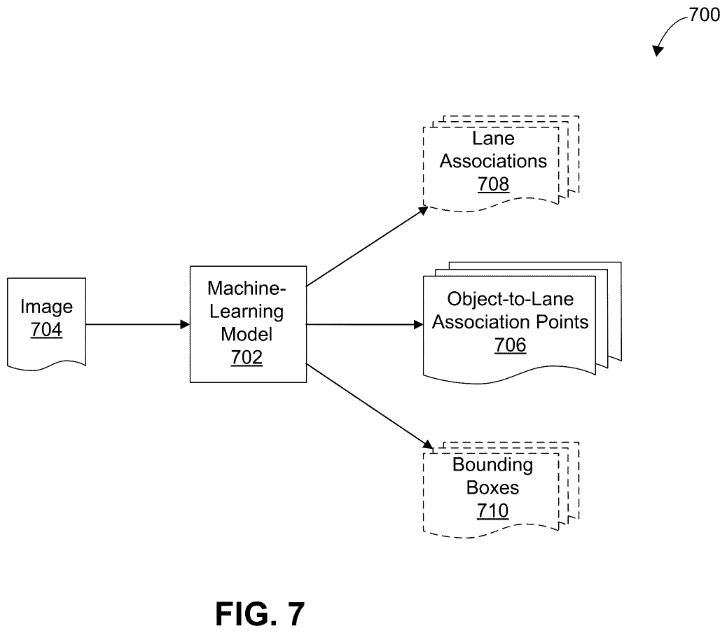

FIG. 7 is a block diagram illustrating an example system 700 for determining lane information, according to various aspects of the present disclosure. System 700 includes a machine-learning model 702 that may receive an image 704 as an input and generate object-to-lane association points 706 as an output. System 700 may be included in an autonomous or semi-autonomous driving system. Object-to-lane association points 706 may be used by the autonomous or semi-autonomous driving system in controlling a vehicle (e.g., based on instruction, restrictions, and/or navigational information provided by objects, such as signs, in image 704). Additionally or alternatively, object-to-lane association points 706 may be used to provide information to a driver.

Image 704 may be an image of a road and one or more objects adjacent to the road. Image 704 may be the same as, or may be substantially similar to, image 104 of FIG. 1. Image 200 of FIG. 2, image 400 of FIG. 4, and/or image 600 of FIG. 6 may be examples of image 704. Object-to-lane association points 706 may be coordinates of edges of lanes. The coordinates may be image coordinates describing edges of the lanes as the edges of the lanes appear in image 704. Additionally or alternatively, the coordinates may be three-dimensional coordinates of the edges of the lanes (e.g., relative to the camera which captured image 704 or in a reference coordinate system). Object-to-lane association points 706 may be associated with objects in image 704. Object-to-lane association points 706 may be the same as, or may be substantially similar to, object-to-lane association points 106 of FIG. 1. Object-to-lane association points 212 and object-to-lane association points 222 of FIG. 2, object-to-lane association points 412, object-to-lane association points 422, object-to-lane association points 432, object-to-lane association points 442, and object-to-lane association points 452 of FIG. 4, and/or object-to-lane association points 612 of FIG. 6 may be examples of object-to-lane association points 706.

Machine-learning model 702 may be, or may include, a trained neural network (e.g., a transformer). Machine-learning model 702 may be trained (e.g., through a backpropagation training process) to generate object-to-lane association points (e.g., image coordinates or three-dimensional coordinates) related to objects based on images. Machine-learning model 702 may be the same as, may be substantially similar to, and/or may perform the same, or substantially the same, operations as machine-learning model 102 of FIG. 1.

Additionally, in some cases, machine-learning model 702 may generate lane associations 708. For example, machine-learning model 702 may be trained to generate lane associations 708 in addition to generating lane edges 706. Machine-learning model 102 may be trained (e.g., through a backpropagation training process) to generate lane associations related to objects based on images. For example, prior to deployment in system 700, machine-learning model 702 may be trained through an iterative training process involving providing machine-learning model 702 with a number of images of roads and signs of a corpus of training data. During the training process, machine-learning model 702 may predict lane associations related to objects in the images. The predicted lane associations may be compared with lane associations of annotations of the images (the annotations may be part of the corpus of training data) and errors between the predicted lane associations and the lane associations of the annotations may be determined. Parameters (e.g., weights) of machine-learning model 702 may be adjusted such that in future iterations of the iterative training, process machine-learning model 702 may more accurately determine the lane associations. Once trained, machine-learning model 702 may be deployed in system 700 and may determine lane associations 708 based on image 704.

Lane associations 708 may be, or may include, an association between objects (e.g., signs) and lanes of a road of image 704. Further, lane associations 708 may include identifiers that are relative to a lane from which image 704 was captured. For example, image 704 may be captured by a camera of a vehicle traveling in a lane. The lane may be referred to as an “ego” lane. Other lanes in the road may be referred to relative to the ego lane. For example, a lane immediately left of the ego lane may be referred to as “OneLaneLeft.” A lane two lanes to the left of the ego lane may be referred to as “TwoLanesLeft,” etc. Similarly lanes to the right of the ego lane may be referred to as “OneLaneRight,” “TwoLanesRight,” etc. As an example, lane associations 708 may include an association between an object (e.g., a sign) and identifiers of lanes to which the object pertains.

Lane associations 708 may include associations not only between objects (e.g., signs) and coordinates (as is included in object-to-lane association points 706) but associations between objects and lanes relative to the ego lane. In some cases, such lane associations may be useful to an autonomous or semi-autonomous driving system because such associations may be more directly relatable to driving decisions. For example, an autonomous or semi-autonomous driving system may make a determination regarding changing lanes based on lane associations 708. However, in some cases, actual roads may not be neatly categorizable into classes relative to an ego lane. For example, in cases where lanes split, and the split lanes split, it may be difficult to categorize some of the split lanes captured by an image relative to an ego lane. In such cases, lane associations 708 may be convoluted and/or not particularly useful. Nevertheless, object-to-lane association points 706 may remain relevant, even in such cases, because object-to-lane association points 706 may associate the objects (e.g., the signs) with the lanes as they appear in the image (e.g., as image coordinates) and/or as the lanes are in a three-dimensional model of the environment without relying on a capability to associate lanes relative to an ego lane. The coordinates may be fixed in time and space and can thus be tracked regardless of lane changes. Further, coordinates (e.g., image coordinates and/or three-dimensional coordinates indicative of lane edges) may be tracked and/or modeled over time. Lane associations 708 are optional in system 700. The optional nature of lane associations 708 in system 700 is illustrated by lane associations 708 being illustrated using dashed lines.

Additionally, in some cases, machine-learning model 702 may generate bounding boxes 710 indicative of image coordinates of objects (e.g., signs) in image 704. For example, machine-learning model 702 may be trained to generate bounding boxes 710 in addition to generating object-to-lane association points 706 and/or lane associations 708. Machine-learning model 702 may be trained (e.g., through a backpropagation training process) to generate bounding boxes of objects in images based on the images. For example, prior to deployment in system 700, machine-learning model 702 may be trained through an iterative training process involving providing machine-learning model 702 with a number of images of roads and signs of a corpus of training data. During the training process, machine-learning model 702 may predict bounding boxes of objects in the images. The predicted bounding boxes may be compared with bounding boxes of annotations of the images (the annotations may be part of the corpus of training data) and errors between the predicted bounding boxes and the bounding boxes the annotations may be determined. Parameters (e.g., weights) of machine-learning model 702 may be adjusted such that in future iterations of the iterative training process, machine-learning model 702 may more accurately determine the image coordinates. Once trained, machine-learning model 702 may be deployed in system 700 and may determine bounding boxes 710 based on image 704.

Bounding boxes 710 may include image coordinates defining shape that describe positions of objects (e.g., signs) in image 704. For example, bounding box 616 of FIG. 6 may describe the position of sign 610 in image 600. Bounding boxes 710 are optional in system 700. The optional nature of bounding boxes 710 in system 700 is illustrated by bounding boxes 710 being illustrated using dashed lines.

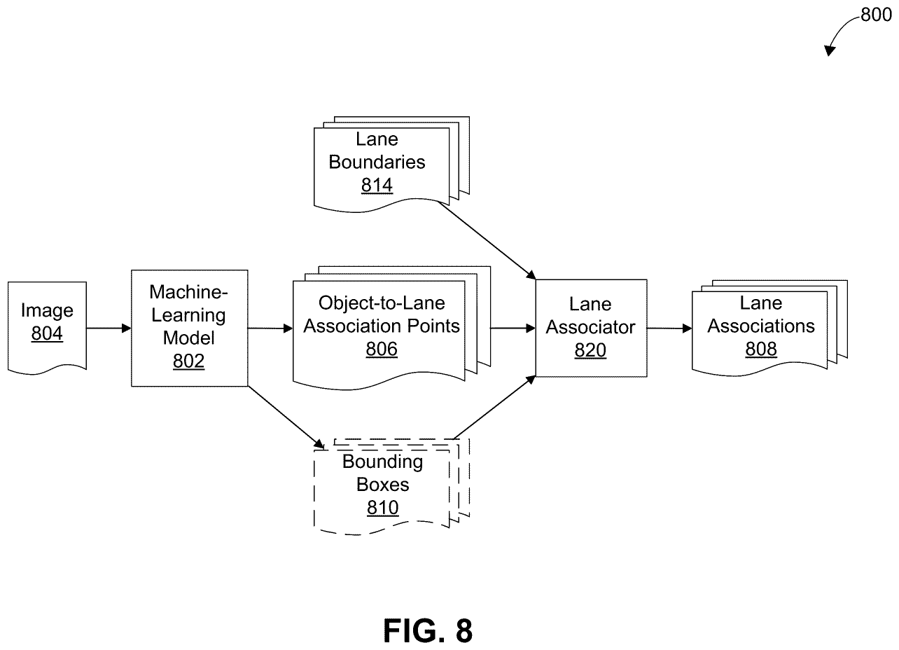

FIG. 8 is a block diagram illustrating an example system 800 for determining lane information, according to various aspects of the present disclosure. System 800 includes a machine-learning model 802 that may receive an image 804 as an input and generate object-to-lane association points 806 as an output. System 800 further includes a lane associator 820 that may associate object-to-lane association points 806 with lane boundaries 814 to generate lane associations 808. System 800 may be included in an autonomous or semi-autonomous driving system. Object-to-lane association points 806 and/or lane associations 808 may be used by the autonomous or semi-autonomous driving system in controlling a vehicle (e.g., based on instruction, restrictions, and/or navigational information provided by objects, such as signs, in image 804). Additionally or alternatively, object-to-lane association points 806 and/or lane associations 808 may be used to provide information to a driver.

Image 804 may be an image of a road and one or more objects adjacent to the road. Image 804 may be the same as, or may be substantially similar to, image 104 of FIG. 1 and/or image 704 of FIG. 7. Image 200 of FIG. 2, image 400 of FIG. 4, and/or image 600 of FIG. 6 may be examples of image 804. Object-to-lane association points 806 may be coordinates of edges of lanes. The coordinates may be image coordinates describing the edges of the lanes as the edges of the lanes appear in image 804. Additionally or alternatively, the coordinates may be three-dimensional coordinates of the edges of the lanes (e.g., relative to a camera which captured image 804 or in a reference coordinate system). Object-to-lane association points 806 may be associated with objects in image 804. Object-to-lane association points 806 may be the same as, or may be substantially similar to, object-to-lane association points 106 of FIG. 1 and/or object-to-lane association points 706 of FIG. 7. Object-to-lane association points 212 and object-to-lane association points 222 of FIG. 2, object-to-lane association points 412, object-to-lane association points 422, object-to-lane association points 432, object-to-lane association points 442, and object-to-lane association points 452 of FIG. 4, and/or object-to-lane association points 612 of FIG. 6 may be examples of object-to-lane association points 806.

Machine-learning model 802 may be, or may include, a trained neural network (e.g., a transformer). Machine-learning model 802 may be trained (e.g., through a backpropagation training process) to generate object-to-lane association points (e.g., image coordinates or three-dimensional coordinates) of lane edges related to objects based on images. Machine-learning model 802 may be the same as, may be substantially similar to, and/or may perform the same, or substantially the same, operations as machine-learning model 102 of FIG. 1 and/or machine-learning model 702 of FIG. 7.

Additionally, in some cases, machine-learning model 802 may generate bounding boxes 810 indicative of image coordinates of objects (e.g., signs) in image 804. For example, machine-learning model 802 may be trained to generate bounding boxes 810 in addition to generating object-to-lane association points 806. Machine-learning model 802 may be trained (e.g., through a backpropagation training process) to generate bounding boxes of objects in images based on the images. Once trained, machine-learning model 802 may be deployed in system 800 and may determine bounding boxes 810 based on image 804.

Bounding boxes 810 may include image coordinates defining shape that describe positions of objects (e.g., signs) in image 804. For example, bounding box 616 of FIG. 6 may describe the position of sign 610 in image 600. Bounding boxes 810 are optional in system 800. The optional nature of bounding boxes 810 in system 800 is illustrated by bounding boxes 810 being illustrated using dashed lines.

Lane boundaries 814 may include image coordinates (or three-dimensional coordinates) corresponding to lane lines in image 804. For example, lane boundaries 814 may include image coordinates (or three-dimensional coordinates) correspond to lane boundary 606 and lane boundary 608 of image 600 of FIG. 6. In some cases, lane boundaries 814 may be associated with lane associations. For example, in some cases, lane boundaries 814 may include identifiers of lanes relative to an ego lane.

In some aspects, Lane associator 820 may generate lane associations 808 based on lane boundaries 814 and object-to-lane association points 806 (and, in some cases, bounding boxes 810). For example, in some aspects, lane associator 820 may be, or may include, a machine-learning model trained to generate lane associations based on object-to-lane association points and/or lane boundaries (and, in some cases, bounding boxes). In other aspects, lane associator 820 may generate lane associations 808 based on rules. In either case, lane associator 820 may take object-to-lane association points 806 and lane boundaries 814 (and, in some cases, bounding boxes 810) as inputs and generate lane associations 808 as an output based thereon.

Lane associations 808 may include associations not only between objects (e.g., signs) and coordinates (as is included in object-to-lane association points 806) but associations between objects and lanes relative to the ego lane. In some cases, such lane associations may be useful to an autonomous or semi-autonomous driving system because such associations may be more directly relatable to driving decisions.

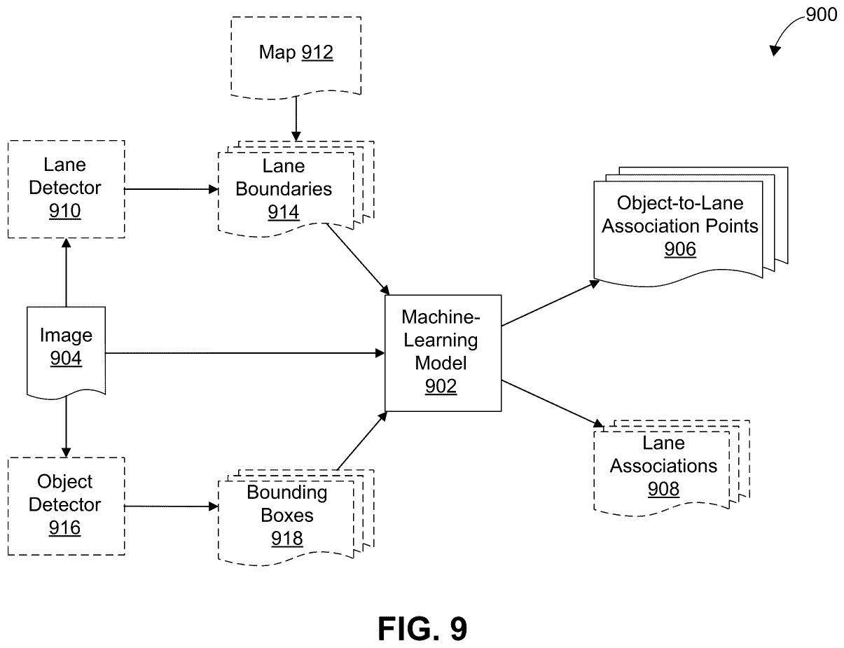

FIG. 9 is a block diagram illustrating an example system 900 for determining lane information, according to various aspects of the present disclosure. System 900 includes a machine-learning model 902 that may receive an image 904 as an input and generate object-to-lane association points 906 as an output. System 900 may be included in an autonomous or semi-autonomous driving system. Object-to-lane association points 906 may be used by the autonomous or semi-autonomous driving system in controlling a vehicle (e.g., based on instruction, restrictions, and/or navigational information provided by objects, such as signs, in image 904). Additionally or alternatively, object-to-lane association points 906 may be used to provide information to a driver.

Image 904 may be an image of a road and one or more objects adjacent to the road. Image 904 may be the same as, or may be substantially similar to, image 104 of FIG. 1, image 704 of FIG. 7, and/or image 804 of FIG. 8. Image 200 of FIG. 2, image 400 of FIG. 4, and/or image 600 of FIG. 6 may be examples of image 904. Object-to-lane association points 906 may be coordinates of edges of lanes. The coordinates may be image coordinates describing edges of the lanes as the edges of the lanes appear in image 904. Additionally or alternatively, the coordinates may be three-dimensional coordinates of the edges of the lanes (e.g., relative to the camera which captured image 904 or in a reference coordinate system). Object-to-lane association points 906 may be associated with objects in image 904. Object-to-lane association points 906 may be the same as, or may be substantially similar to, object-to-lane association points 106 of FIG. 1, object-to-lane association points 706 of FIG. 7, and/or object-to-lane association points 806 of FIG. 8. Object-to-lane association points 212 and object-to-lane association points 222 of FIG. 2, object-to-lane association points 412, object-to-lane association points 422, object-to-lane association points 432, object-to-lane association points 442, and object-to-lane association points 452 of FIG. 4, and/or object-to-lane association points 612 of FIG. 6 may be examples of object-to-lane association points 906.

Machine-learning model 902 may be, or may include, a trained neural network (e.g., a transformer). Machine-learning model 902 may be trained (e.g., through a backpropagation training process) to generate coordinates (e.g., image coordinates or three-dimensional coordinates) of lane edges related to objects based on images. Machine-learning model 902 may be the same as, may be substantially similar to, and/or may perform the same, or substantially the same, operations as machine-learning model 102 of FIG. 1, machine-learning model 702 of FIG. 7, and/or machine-learning model 802 of FIG. 8.

Additionally, in some cases, machine-learning model 902 may generate lane associations 908. For example, machine-learning model 902 may be trained to generate lane associations 908 in addition to generating object-to-lane association points 906. Lane associations 908 may be the same as, or may be substantially similar to, lane associations 708 of FIG. 7 and/or lane associations 808 of FIG. 8. Lane associations 908 are optional in system 900. The optional nature of lane associations 908 in system 900 is illustrated by lane associations 908 being illustrated using dashed lines.

In some aspects, system 900 may include a lane detector 910 that may generate lane boundaries 914 based on image 904. Lane detector 910 may generate lane boundaries 914 using any suitable technique. For example, lane detector 910 may include a neural network (e.g., a transformer) trained to detect lanes. In some aspects, lane boundaries 914 may be derived from a map 912, for example, a map of the environment in which the vehicle which captured image 904 is traveling. In any case, Lane boundaries 914 may include image coordinates (or three-dimensional coordinates) corresponding to lane lines in image 904. For example, lane boundaries 914 may include image coordinates (or three-dimensional coordinates) correspond to lane boundary 606 and lane boundary 608 of image 600 of FIG. 6. In some cases, lane boundaries 914 may be associated with lane associations. For example, in some cases, lane boundaries 914 may include identifiers of lanes relative to an ego lane. In some aspects, machine-learning model 902 may generate object-to-lane association points 906 and/or lane associations 908 based on lane boundaries 914. For example, machine-learning model 902 may take image 904 and lane boundaries 914 as inputs and generate object-to-lane association points 906 and/or lane associations 908 as outputs based thereon. For example, machine-learning model 902 may have been trained through a training process that involved providing images and lane boundaries as inputs. Lane detector 910, map 912, and lane boundaries 914 are optional in system 900. The optional nature of lane detector 910, map 912, and lane boundaries 914 in system 900 is illustrated by lane detector 910, map 912, and lane boundaries 914 being illustrated using dashed lines.

In some aspects, system 900 may include an object detector 916 that may generate bounding boxes 918 based on image 904. object detector 916 may generate bounding boxes 918 using any suitable technique. For example, object detector 916 may include a neural network (e.g., a transformer) trained to detect objects. Bounding boxes 918 may be the same as, or may be substantially similar to, bounding boxes 710 of FIG. 7 and/or bounding boxes 810 of FIG. 8. In some aspects, machine-learning model 902 may generate object-to-lane association points 906 and/or lane associations 908 based on bounding boxes 918. For example, machine-learning model 902 may take image 904 and bounding boxes 918 as inputs and generate object-to-lane association points 906 and/or lane associations 908 as outputs based thereon. For example, machine-learning model 902 may have been trained through a training process that involved providing images and bounding boxes as inputs. Object detector 916 and bounding boxes 918 are optional in system 900. The optional nature of object detector 916 and bounding boxes 918 in system 900 is illustrated by object detector 916 and bounding boxes 918 being illustrated using dashed lines.

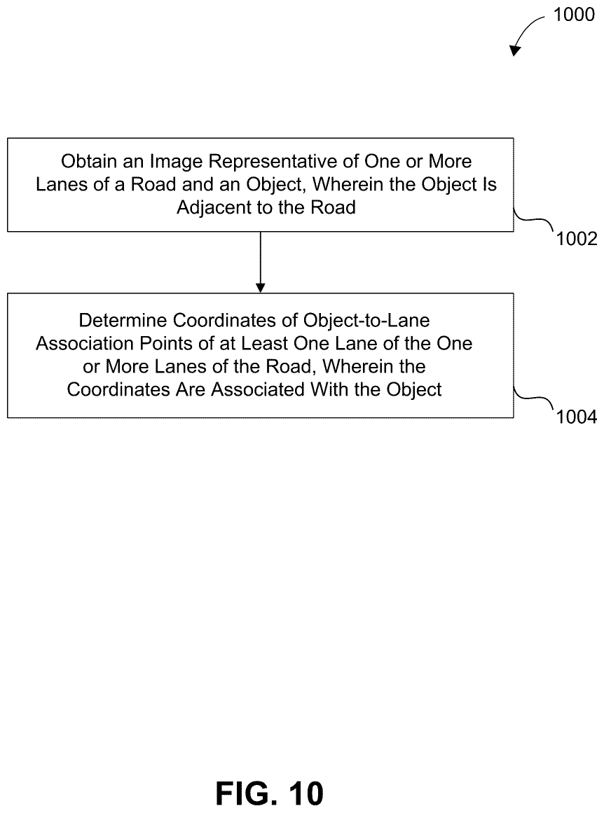

FIG. 10 is a flow diagram illustrating a process 1000 for determining lane information, in accordance with aspects of the present disclosure. One or more operations of process 1000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1000. The one or more operations of process 1000 may be implemented as software components that are executed and run on one or more processors.

At block 1002, a computing device (or one or more components thereof) may obtain an image representative of one or more lanes of a road and an object, wherein the object is adjacent to the road. For example, machine-learning model 102 of FIG. 1 may obtain image 104. As another example, machine-learning model 702 of FIG. 7 may obtain image 704. As another example, machine-learning model 802 of FIG. 8 may obtain image 804. As another example, machine-learning model 902 of FIG. 9 may obtain image 904. Image 200 of FIG. 2 may be an example of the image, for example, including lane 202, lane 204, and lane 206 of a road and sign 210 and sign 220 adjacent to the road. Image 200 of FIG. 2 may be an example of the image, for example, including lane 202, lane 204, and lane 206 of a road and sign 210 and sign 220 adjacent to the road. Image 400 of FIG. 4 may be an example of the image, for example, including lane 402, lane 404, and lane 406 of a road and sign 410, sign 420, sign 430, sign 440, and sign 450 adjacent to the road. Image 600 of FIG. 6 may be an example of the image, for example, including lane 602 and lane 604 of a road and sign 610 adjacent to the road.

At block 1004, the computing device (or one or more components thereof) may determine coordinates of object-to-lane association points of at least one lane of the one or more lanes of the road, wherein the coordinates are associated with the object. For example, machine-learning model 102 of FIG. 1 may determine object-to-lane association points 106. As another example, machine-learning model 702 of FIG. 7 may generate object-to-lane association points 706. As another example, machine-learning model 802 of FIG. 8 may generate object-to-lane association points 806. As another example, machine-learning model 902 of FIG. 9 may generate object-to-lane association points 906.

In some aspects, the coordinates may be, or may include, image coordinates. For example, object-to-lane association points 212 and object-to-lane association points 222 of FIG. 2 may be examples of the determined object-to-lane association points. For example, object-to-lane association points 212 may be, or may include, image coordinates of image 200.

In some aspects, the coordinates may be, or may include, image coordinates. For example, object-to-lane association points 412, object-to-lane association points 422, object-to-lane association points 432, object-to-lane association points 442, and object-to-lane association points 452 of FIG. 4 may be examples of the determined object-to-lane association points. For example, object-to-lane association points 412, object-to-lane association points 422, object-to-lane association points 432, object-to-lane association points 442, and object-to-lane association points 452 may be, or may include, image coordinates of image 400.

In some aspects, the coordinates may be, or may include, image coordinates that are laterally offset in the image from the object in the image. For example, object-to-lane association points 212 are offset in image 200 from sign 210, line 434 are laterally offset from sign 430, object-to-lane association points 452 are laterally offset from sign 450, and object-to-lane association points 612 are laterally offset from sign 610.

In some aspects, the coordinates may be, or may include, image coordinates that are at a level of the road in the image. For example, object-to-lane association points 212 and object-to-lane association points 222, may be at a level of lane 206 in image 200, object-to-lane association points 412 and object-to-lane association points 422 may be at a level of lane 402 and lane 404 in image 400, object-to-lane association points 432 may be at a level of lane 402, lane 404, and lane 406 in image 400, object-to-lane association points 442 and object-to-lane association points 452 may be at a level of lane 406 in image 400, and object-to-lane association points 612 may be at a level of lane 602 in image 600.

In some aspects, the coordinates may be, or may include, image coordinates that are lower in the image than the object. For example, object-to-lane association points 212 is lower in image 200 than sign 210, object-to-lane association points 222 is lower in image 200 than sign 220, object-to-lane association points 412 is lower in image 400 than sign 410, object-to-lane association points 422 is lower in image 400 than sign 420, object-to-lane association points 432 is lower in image 400 than sign 430, object-to-lane association points 442 is lower in image 400 than sign 440, object-to-lane association points 452 is lower in image 400 than sign 450, and object-to-lane association points 612 is lower in image 600 than sign 610.

In some aspects, the coordinates comprise image coordinates and a line between the image coordinates is substantially perpendicular to a direction of travel of the at least one lane.

For example, line 214 between object-to-lane association points 212 may be perpendicular to a direction of travel in lane 206, line 224 between object-to-lane association points 222 may be perpendicular to a direction of travel in lane 206, line 414 between object-to-lane association points 412 may be perpendicular to a direction of travel in lane 402 and/or lane 404 (or an average direction of travel between lane 402 and lane 404), line 424 between object-to-lane association points 422 may be perpendicular to a direction of travel in lane 402 and/or lane 404 (or an average direction of travel between lane 402 and lane 404), line 434 between object-to-lane association points 432 may be perpendicular to a direction of travel in lane 402, lane 404, and/or lane 406 (or an average direction of travel between lane 402, lane 404, and/or lane 406), line 444 between object-to-lane association points 442 may be perpendicular to a direction of travel in lane 406, line 454 between object-to-lane association points 452 may be perpendicular to a direction of travel in lane 406, and line 614 between object-to-lane association points 612 may be perpendicular to a direction of travel in lane 602.

In some aspects, the coordinates may be, or may include, three-dimensional coordinates. For example, object-to-lane association points 212 and object-to-lane association points 222 of FIG. 3 may be examples of the determined object-to-lane association points. For example, object-to-lane association points 212 may be, or may include three-dimensional coordinates (e.g., mapped onto bird's-eye-view representation 300 for illustrative purpose). Object-to-lane association points 212 may be associated with sign 210 and object-to-lane association points 222 may be associated with sign 220.

In some aspects, the coordinates may be, or may include, three-dimensional coordinates. For example, object-to-lane association points 412, object-to-lane association points 422, object-to-lane association points 432, object-to-lane association points 442, and object-to-lane association points 452 of FIG. 5 may be examples of the determined object-to-lane association points. For example, object-to-lane association points 412, object-to-lane association points 422, object-to-lane association points 432, object-to-lane association points 442, and object-to-lane association points 452 may be, or may include three-dimensional coordinates (e.g., mapped onto bird's-eye-view representation 500 for illustrative purpose). Object-to-lane association points 412 may be associated with sign 410, object-to-lane association points 422 may be associated with sign 420, object-to-lane association points 432 may be associated with sign 430, object-to-lane association points 442 may be associated with sign 440, and object-to-lane association points 452 may be associated with sign 450. Object-to-lane association points 612 of FIG. 6 may be examples of the determined object-to-lane association points. Object-to-lane association points 612 may be associated with sign 610.

In some aspects, the three-dimensional coordinates may be relative to a camera which captured the image. For example, the coordinates may include an indication of distance in three orthogonal directions from the camera. Alternatively the coordinates may include an indication of a azimuth angle an elevation angle and a distance between the coordinates and the camera. In some aspects, the three-dimensional coordinates may be relative to a reference coordinate system. For example, the coordinates may include a latitude and a longitude.

In some aspects, the object may be, or may include, a sign that relates to the at least one lane. In some aspects, the object may be, or may include, a road sign providing information that pertains to the at least one lane. Sign 210 and sign 220 of FIG. 2, sign 410, sign 420, sign 430, sign 440, and sign 450 of FIG. 4, and sign 610 of FIG. 6 are examples of the object.

In some aspects, the coordinates may be indicative of the at least one lane to which the object relates. For example, object-to-lane association points 212 may be indicative of a lane to which sign 210 pertains, object-to-lane association points 222 may be indicative of a lane to which sign 220 pertains, object-to-lane association points 412 may be indicative of a lane to which sign 410 pertains, object-to-lane association points 422 may be indicative of a lane to which sign 420 pertains, object-to-lane association points 432 may be indicative of a lane to which sign 430 pertains, object-to-lane association points 442 may be indicative of a lane to which sign 440 pertains, and object-to-lane association points 452 may be indicative of a lane to which sign 450 pertains.

In some aspects, to determine the coordinates, the computing device (or one or more components thereof) may provide the image to a neural network trained to determine coordinates representative of object-to-lane association points associated with objects; and obtain the coordinates from the neural network. For example, the computing device (or one or more components thereof) may provide image 104 to machine-learning model 102 of FIG. 1 and machine-learning model 102 may generate object-to-lane association points 106. As another example, the computing device (or one or more components thereof) may provide image 704 to machine-learning model 702 of FIG. 7 and machine-learning model 702 may generate object-to-lane association points 706. As another example, the computing device (or one or more components thereof) may provide image 804 to machine-learning model 802 of FIG. 8 and machine-learning model 802 may generate object-to-lane association points 806. As another example, the computing device (or one or more components thereof) may provide image 904 to machine-learning model 902 of FIG. 9 and machine-learning model 902 may generate object-to-lane association points 906.

In some aspects, the coordinates may be, or may include, image coordinates and the neural network may be trained to determine image coordinates of object-to-lane association points. For example, machine-learning model 102, machine-learning model 702, machine-learning model 802, and/or machine-learning model 902 may be trained to generate image coordinates based on images.

In some aspects, the coordinates may be, or may include, three-dimensional coordinates and the neural network may be trained to determine three-dimensional coordinates of object-to-lane association points. For example, machine-learning model 102, machine-learning model 702, machine-learning model 802, and/or machine-learning model 902 may be trained to generate three-dimensional coordinates based on images.

In some aspects, the computing device (or one or more components thereof) may obtain lane boundaries related to the image and associate the lane boundaries with the object based on the coordinates. For example, system 800 of FIG. 8 may obtain lane boundaries 814 and associate objects of image 804 with lane boundaries 814 based on object-to-lane association points 806.

In some aspects, to obtain the lane boundaries, the computing device (or one or more components thereof) may provide the image to a neural network trained to determine lane boundaries based on images and obtain the lane boundaries from the neural network. For example, system 900 of FIG. 9 may provide image 904 to lane detector 910. Lane detector 910 may generate lane boundaries 914 based on image 904. Machine-learning model 902 may associate objects of image 904 with lane boundaries 914 based on object-to-lane association points 906. In some aspects, the lane boundaries may be based on map information. For example, lane detector 910 may generate lane boundaries 914 based on map 912.

In some aspects, the computing device (or one or more components thereof) may provide the image to a neural network trained to determine coordinates representative of lane edges associated with objects and lane boundaries; obtain the coordinates from the neural network; and obtain lane boundaries from the neural network. For example, system 900 of FIG. 9 may provide image 904 to lane detector 910. Lane detector 910 may generate lane boundaries 914 based on image 904.

In some aspects, the computing device (or one or more components thereof) may provide the image to a neural network trained to determine bounding boxes and obtain a bounding box related to the object from the neural network. For example, system 900 may provide image 904 to object detector 916 and object detector 916 may determine bounding boxes 918 based on image 904.

In some aspects, the coordinates are determined based on the bounding box. For example, machine-learning model 902 may determine object-to-lane association points 906 based, at least in part, on bounding boxes 918.

In some aspects, the computing device (or one or more components thereof) may determine bird's-eye-view coordinates corresponding to the object-to-lane association points of the at least one lane of the one or more lanes of the road based on the coordinates. For example, machine-learning model 102, machine-learning model 702, machine-learning model 802, and/or machine-learning model 902 may determine bird's-eye-view coordinates. For example, object-to-lane association points 212 and object-to-lane association points 222 as illustrated in bird's-eye-view representation 300 of FIG. 3 may be bird's-eye-view coordinates. As an example, object-to-lane association points 412, object-to-lane association points 422, object-to-lane association points 432, object-to-lane association points 442, and object-to-lane association points 452 as illustrated in bird's-eye-view representation 500 of FIG. 5 may be bird's-eye-view coordinates. In some aspects, the computing device (or one or more components thereof) may track the bird's-eye-view coordinates based on successive images.

In some aspects, the computing device (or one or more components thereof) may determine three-dimensional coordinates corresponding to the object-to-lane association points of the at least one lane of the one or more lanes of the road based on the coordinates. For example, machine-learning model 102, machine-learning model 702, machine-learning model 802, and/or machine-learning model 902 may determine three-dimensional coordinates.

For example, object-to-lane association points 212 and object-to-lane association points 222 as illustrated in bird's-eye-view representation 300 of FIG. 3 may be three-dimensional coordinates (e.g., projected onto a two-dimensional map, such as bird's-eye-view representation 300). As an example, object-to-lane association points 412, object-to-lane association points 422, object-to-lane association points 432, object-to-lane association points 442, and object-to-lane association points 452 as illustrated in bird's-eye-view representation 500 of FIG. 5 may be three-dimensional coordinates (e.g., projected onto a two-dimensional map, such as bird's-eye-view representation 500). In some aspects, the computing device (or one or more components thereof) may track the three-dimensional coordinates based on successive images.

In some aspects, the computing device (or one or more components thereof) may control a vehicle based on the coordinates. In some aspects, the computing device (or one or more components thereof) may provide information to a driver of a vehicle based on the coordinates.

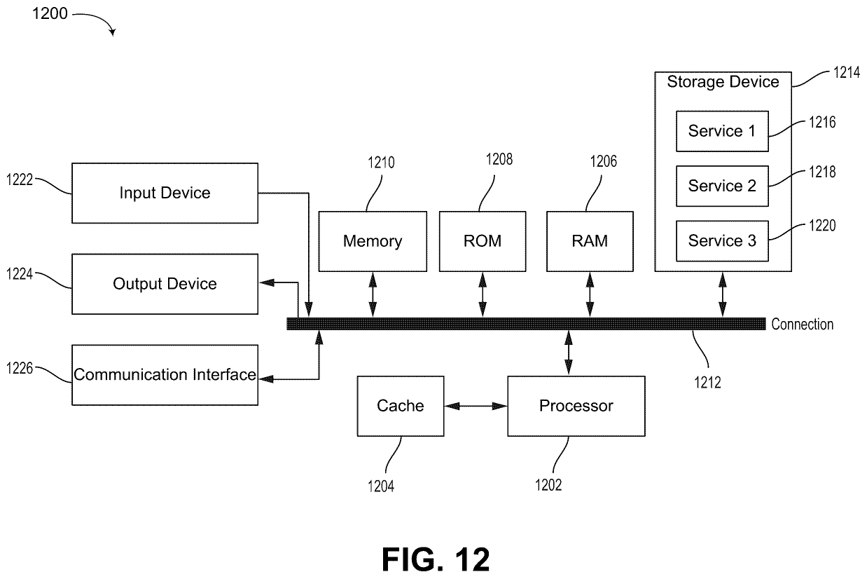

In some examples, as noted previously, the methods described herein (e.g., process 1000 of FIG. 10, and/or other methods described herein) can be performed, in whole or in part, by a computing device or apparatus. In one example, one or more of the methods can be performed by system 100 of FIG. 1, system 700 of FIG. 7, system 900 of FIG. 9, or by another system or device. In another example, one or more of the methods (e.g., process 1000 of FIG. 10, and/or other methods described herein) can be performed, in whole or in part, by the computing-device architecture 1200 shown in FIG. 12. For instance, a computing device with the computing-device architecture 1200 shown in FIG. 12 can include, or be included in, the components of the system 100, system 700, and/or system 900 and can implement the operations of process 1000, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1000, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1000, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

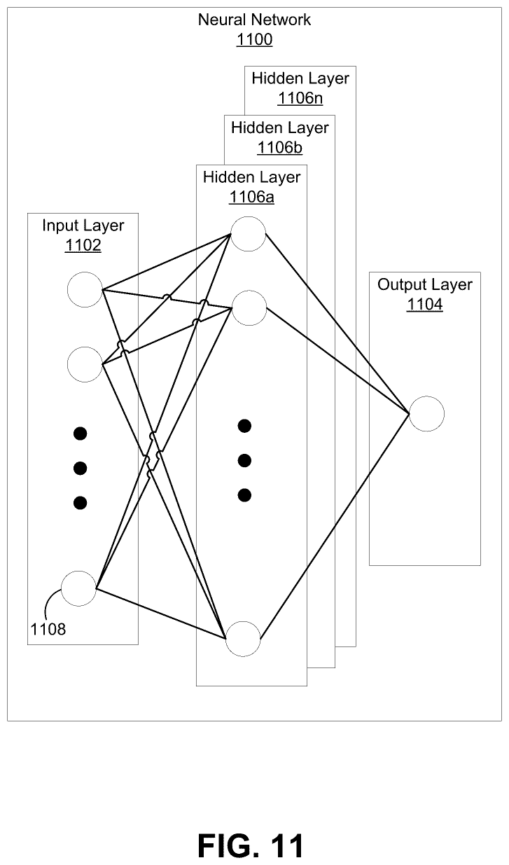

FIG. 11 is an illustrative example of a neural network 1100 (e.g., a deep-learning neural network) that can be used to implement machine-learning based object detection, lane detection, lane association, lane-edge determination, feature segmentation, implicit-neural-representation generation, rendering, classification, image recognition (e.g., face recognition, object recognition, scene recognition, etc.), feature extraction, authentication, gaze detection, gaze prediction, and/or automation. For example, neural network 1100 may be an example of, or can implement, machine-learning model 102 of FIG. 1, machine-learning model 702 of FIG. 7, machine-learning model 902 of FIG. 9, lane detector 910 of FIG. 9, and/or object detector 916, of FIG. 9.

An input layer 1102 includes input data. In one illustrative example, input layer 1102 can include data representing image 104 of FIG. 1, image 200 of FIG. 2, image 400 of FIG. 4, image 600 of FIG. 6, image 704 of FIG. 7, image 904 of FIG. 9, lane boundaries 914 of FIG. 9, and/or bounding boxes 918 of FIG. 9. Neural network 1100 includes multiple hidden layers hidden layers 1006a, 1006b, through 1006n. The hidden layers 1006a, 1006b, through hidden layer 1006n include “n” number of hidden layers, where “n” is an integer greater than or equal to one. The number of hidden layers can be made to include as many layers as needed for the given application. Neural network 1100 further includes an output layer 1104 that provides an output resulting from the processing performed by the hidden layers 1006a, 1006b, through 1006n. In one illustrative example, output layer 1104 can provide object-to-lane association points 106 of FIG. 1, object-to-lane association points 212, line 214, object-to-lane association points 222, and/or line 224 of FIG. 2, object-to-lane association points 412, line 414, object-to-lane association points 422, line 424, object-to-lane association points 432, line 434, object-to-lane association points 442, line 444, object-to-lane association points 452, and/or line 454 of FIG. 4, object-to-lane association points 612 and/or line 614 of FIG. 6, object-to-lane association points 706, lane associations 708, and/or bounding boxes 710 of FIG. 7, and/or object-to-lane association points 906 and/or lane associations 908 of FIG. 9.

Neural network 1100 may be, or may include, a multi-layer neural network of interconnected nodes. Each node can represent a piece of information. Information associated with the nodes is shared among the different layers and each layer retains information as information is processed. In some cases, neural network 1100 can include a feed-forward network, in which case there are no feedback connections where outputs of the network are fed back into itself. In some cases, neural network 1100 can include a recurrent neural network, which can have loops that allow information to be carried across nodes while reading in input.

Information can be exchanged between nodes through node-to-node interconnections between the various layers. Nodes of input layer 1102 can activate a set of nodes in the first hidden layer 1006a. For example, as shown, each of the input nodes of input layer 1102 is connected to each of the nodes of the first hidden layer 1006a. The nodes of first hidden layer 1006a can transform the information of each input node by applying activation functions to the input node information. The information derived from the transformation can then be passed to and can activate the nodes of the next hidden layer 1006b, which can perform their own designated functions. Example functions include convolutional, up-sampling, data transformation, and/or any other suitable functions. The output of the hidden layer 1006b can then activate nodes of the next hidden layer, and so on. The output of the last hidden layer 1006n can activate one or more nodes of the output layer 1104, at which an output is provided. In some cases, while nodes (e.g., node 1108) in neural network 1100 are shown as having multiple output lines, a node has a single output and all lines shown as being output from a node represent the same output value.

In some cases, each node or interconnection between nodes can have a weight that is a set of parameters derived from the training of neural network 1100. Once neural network 1100 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1100 to be adaptive to inputs and able to learn as more and more data is processed.

Neural network 1100 may be pre-trained to process the features from the data in the input layer 1102 using the different hidden layers 1006a, 1006b, through 1006n in order to provide the output through the output layer 1104. In an example in which neural network 1100 is used to identify features in images, neural network 1100 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1100 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1100 is trained well enough so that the weights of the layers are accurately tuned.

For the example of identifying objects in images, the forward pass can include passing a training image through neural network 1100. The weights are initially randomized before neural network 1100 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1100, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1100 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1100 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1100 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1100 can include any other deep network other than a CNN, such as a transformer, an autoencoder, a deep belief nets (DBNs), a Recurrent Neural Networks (RNNs), among others.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of system 100 of FIG. 1, system 700 of FIG. 7, and/or system 900 of FIG. 9. Additionally or alternatively, computing-device architecture 1200 may be configured to perform process 1000, and/or other process described herein.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data. These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1206, read only memory (ROM) 1208, and hybrids thereof. Storage device 1214 can include services 1216, 1218, and 1220 for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C. A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for determining lane information, the apparatus comprising: at least one memory; and at least one processor coupled to the at least one memory and configured to: obtain an image representative of one or more lanes of a road and an object, wherein the object is adjacent to the road; and determine coordinates of object-to-lane association points of at least one lane of the one or more lanes of the road, wherein the coordinates are associated with the object.

Aspect 2. The apparatus of aspect 1, wherein the coordinates comprise image coordinates.

Aspect 3. The apparatus of any one of aspects 1 or 2, wherein the coordinates comprise three-dimensional coordinates.

Aspect 4. The apparatus of aspect 3, wherein the three-dimensional coordinates are relative to a camera which captured the image.

Aspect 5. The apparatus of any one of aspects 3 or 4, wherein the three-dimensional coordinates are relative to a reference coordinate system.

Aspect 6. The apparatus of any one of aspects 1 to 5, wherein the object comprises a sign that relates to the at least one lane.

Aspect 7. The apparatus of any one of aspects 1 to 6, wherein the object comprises a road sign providing information that pertains to the at least one lane.

Aspect 8. The apparatus of any one of aspects 1 to 7, wherein the coordinates are indicative of the at least one lane to which the object relates.

Aspect 9. The apparatus of any one of aspects 1 to 8, wherein the coordinates comprise image coordinates that are laterally offset in the image from the object in the image.

Aspect 10. The apparatus of any one of aspects 1 to 9, wherein the coordinates comprise image coordinates that are at a level of the road in the image.

Aspect 11. The apparatus of any one of aspects 1 to 10, wherein the coordinates comprise image coordinates that are lower in the image than the object.

Aspect 12. The apparatus of any one of aspects 1 to 11, wherein the coordinates comprise image coordinates and wherein a line between the image coordinates is substantially perpendicular to a direction of travel of the at least one lane.

Aspect 13. The apparatus of any one of aspects 1 to 12, wherein, to determine the coordinates, the at least one processor is configured to: provide the image to a neural network trained to determine coordinates representative of object-to-lane association points associated with objects; and obtain the coordinates from the neural network.

Aspect 14. The apparatus of aspect 13, wherein the coordinates comprise image coordinates and wherein the neural network is trained to determine image coordinates of object-to-lane association points.

Aspect 15. The apparatus of any one of aspects 13 or 14, wherein the coordinates comprise three-dimensional coordinates and wherein the neural network is trained to determine three-dimensional coordinates of object-to-lane association points.

Aspect 16. The apparatus of any one of aspects 1 to 15, wherein the at least one processor is further configured to: obtain lane boundaries related to the image; and associate the lane boundaries with the object based on the coordinates.

Aspect 17. The apparatus of aspect 16, wherein, to obtain the lane boundaries, the at least one processor is configured to: provide the image to a neural network trained to determine lane boundaries based on images; and obtain the lane boundaries from the neural network.

Aspect 18. The apparatus of any one of aspects 16 or 17, wherein the lane boundaries are based on map information.

Aspect 19. The apparatus of any one of aspects 1 to 18, wherein the at least one processor is further configured to: provide the image to a neural network trained to determine coordinates representative of lane edges associated with objects and lane boundaries; obtain the coordinates from the neural network; and obtain lane boundaries from the neural network.

Aspect 20. The apparatus of any one of aspects 1 to 19, wherein the at least one processor is further configured to: provide the image to a neural network trained to determine bounding boxes; and obtain a bounding box related to the object from the neural network.

Aspect 21. The apparatus of aspect 20, wherein the coordinates are determined based on the bounding box.

Aspect 22. The apparatus of any one of aspects 1 to 21, wherein the at least one processor is further configured to determine bird's-eye-view coordinates corresponding to the object-to-lane association points of the at least one lane of the one or more lanes of the road based on the coordinates.

Aspect 23. The apparatus of aspect 22, wherein the at least one processor is further configured to track the bird's-eye-view coordinates based on successive images.

Aspect 24. The apparatus of any one of aspects 1 to 23, wherein the at least one processor is further configured to determine three-dimensional coordinates corresponding to the object-to-lane association points of the at least one lane of the one or more lanes of the road based on the coordinates.

Aspect 25. The apparatus of aspect 24, wherein the at least one processor is further configured to track the three-dimensional coordinates based on successive images.

Aspect 26. The apparatus of any one of aspects 1 to 25, wherein the at least one processor is further configured to control a vehicle based on the coordinates.

Aspect 27. The apparatus of any one of aspects 1 to 26, wherein the at least one processor is further configured to provide information to a driver of a vehicle based on the coordinates.

Aspect 28. A method for determining lane information, the method comprising: obtaining an image representative of one or more lanes of a road and an object, wherein the object is adjacent to the road; and determining coordinates of object-to-lane association points of at least one lane of the one or more lanes of the road, wherein the coordinates are associated with the object.

Aspect 29. The method of aspect 28, wherein the coordinates comprise image coordinates.

Aspect 30. The method of any one of aspects 28 or 29, wherein the coordinates comprise three-dimensional coordinates.

Aspect 31. The method of aspect 30, wherein the three-dimensional coordinates are relative to a camera which captured the image.

Aspect 32. The method of any one of aspects 30 or 31, wherein the three-dimensional coordinates are relative to a reference coordinate system.

Aspect 33. The method of any one of aspects 28 to 32, wherein the object comprises a sign that relates to the at least one lane.

Aspect 34. The method of any one of aspects 28 to 33, wherein the object comprises a road sign providing information that pertains to the at least one lane.

Aspect 35. The method of any one of aspects 28 to 34, wherein the coordinates are indicative of the at least one lane to which the object relates.

Aspect 36. The method of any one of aspects 28 to 35, wherein the coordinates comprise image coordinates that are laterally offset in the image from the object in the image.

Aspect 37. The method of any one of aspects 28 to 36, wherein the coordinates comprise image coordinates that are at a level of the road in the image.

Aspect 38. The method of any one of aspects 28 to 37, wherein the coordinates comprise image coordinates that are lower in the image than the object.

Aspect 39. The method of any one of aspects 28 to 38, wherein the coordinates comprise image coordinates and wherein a line between the image coordinates is substantially perpendicular to a direction of travel of the at least one lane.

Aspect 40. The method of any one of aspects 28 to 39, wherein determining the coordinates comprises: providing the image to a neural network trained to determine coordinates representative of object-to-lane association points associated with objects; and obtaining the coordinates from the neural network.

Aspect 41. The method of aspect 40, wherein the coordinates comprise image coordinates and wherein the neural network is trained to determine image coordinates of object-to-lane association points.

Aspect 42. The method of any one of aspects 40 or 41, wherein the coordinates comprise three-dimensional coordinates and wherein the neural network is trained to determine three-dimensional coordinates of object-to-lane association points.

Aspect 43. The method of any one of aspects 28 to 42, further comprising: obtaining lane boundaries related to the image; and associating the lane boundaries with the object based on the coordinates.

Aspect 44. The method of aspect 43, wherein obtaining the lane boundaries comprises: providing the image to a neural network trained to determine lane boundaries based on images; and obtaining the lane boundaries from the neural network.

Aspect 45. The method of any one of aspects 43 or 44, wherein the lane boundaries are based on map information.

Aspect 46. The method of any one of aspects 28 to 45, further comprising: providing the image to a neural network trained to determine coordinates representative of lane edges associated with objects and lane boundaries; obtaining the coordinates from the neural network; and obtaining lane boundaries from the neural network.

Aspect 47. The method of any one of aspects 28 to 46, further comprising: providing the image to a neural network trained to determine bounding boxes; and obtaining a bounding box related to the object from the neural network.

Aspect 48. The method of aspect 47, wherein the coordinates are determined based on the bounding box.

Aspect 49. The method of any one of aspects 28 to 48, further comprising determining bird's-eye-view coordinates corresponding to the object-to-lane association points of the at least one lane of the one or more lanes of the road based on the coordinates.

Aspect 50. The method of aspect 49, further comprising tracking the bird's-eye-view coordinates based on successive images.

Aspect 51. The method of any one of aspects 28 to 50, further comprising determining three-dimensional coordinates corresponding to the object-to-lane association points of the at least one lane of the one or more lanes of the road based on the coordinates.

Aspect 52. The method of aspect 51, further comprising tracking the three-dimensional coordinates based on successive images.

Aspect 53. The method of any one of aspects 28 to 52, further comprising controlling a vehicle based on the coordinates.

Aspect 54. The method of any one of aspects 28 to 53, further comprising providing information to a driver of a vehicle based on the coordinates.

Aspect 55. A non-transitory computer-readable storage medium having stored thereon instructions that, when executed by at least one processor, cause the at least one processor to perform operations according to any of aspects 28 to 54.

Aspect 56. An apparatus for providing virtual content for display, the apparatus comprising one or more means for perform operations according to any of aspects 28 to 54.

What is claimed is:

1. An apparatus for determining lane information, the apparatus comprising:
at least one memory; and
at least one processor coupled to the at least one memory and configured to:
obtain an image representative of one or more lanes of a road and an object, wherein the object is adjacent to the road; and
determine coordinates of object-to-lane association points of at least one lane of the one or more lanes of the road, wherein the coordinates are associated with the object.

2. The apparatus of claim 1, wherein the coordinates comprise image coordinates.

3. The apparatus of claim 1, wherein the coordinates comprise three-dimensional coordinates.

4. The apparatus of claim 3, wherein the three-dimensional coordinates are relative to a camera which captured the image.

5. The apparatus of claim 3, wherein the three-dimensional coordinates are relative to a reference coordinate system.

6. The apparatus of claim 1, wherein the object comprises a sign that relates to the at least one lane.

7. The apparatus of claim 1, wherein the object comprises a road sign providing information that pertains to the at least one lane.

8. The apparatus of claim 1, wherein the coordinates are indicative of the at least one lane to which the object relates.

9. The apparatus of claim 1, wherein the coordinates comprise image coordinates that are laterally offset in the image from the object in the image.

10. The apparatus of claim 1, wherein the coordinates comprise image coordinates that are at a level of the road in the image.

11. The apparatus of claim 1, wherein the coordinates comprise image coordinates that are lower in the image than the object.

12. The apparatus of claim 1, wherein the coordinates comprise image coordinates and wherein a line between the image coordinates is substantially perpendicular to a direction of travel of the at least one lane.

13. The apparatus of claim 1, wherein, to determine the coordinates, the at least one processor is configured to:
provide the image to a neural network trained to determine coordinates representative of object-to-lane association points associated with objects; and
obtain the coordinates from the neural network.

14. The apparatus of claim 13, wherein the coordinates comprise image coordinates and wherein the neural network is trained to determine image coordinates of object-to-lane association points.

15. The apparatus of claim 13, wherein the coordinates comprise three-dimensional coordinates and wherein the neural network is trained to determine three-dimensional coordinates of object-to-lane association points.

16. The apparatus of claim 1, wherein the at least one processor is further configured to:
obtain lane boundaries related to the image; and
associate the lane boundaries with the object based on the coordinates.

17. The apparatus of claim 16, wherein, to obtain the lane boundaries, the at least one processor is configured to:
provide the image to a neural network trained to determine lane boundaries based on images; and
obtain the lane boundaries from the neural network.

18. The apparatus of claim 16, wherein the lane boundaries are based on map information.

19. The apparatus of claim 1, wherein the at least one processor is further configured to:
provide the image to a neural network trained to determine coordinates representative of lane edges associated with objects and lane boundaries;
obtain the coordinates from the neural network; and
obtain lane boundaries from the neural network.

20. The apparatus of claim 1, wherein the at least one processor is further configured to:
provide the image to a neural network trained to determine bounding boxes; and
obtain a bounding box related to the object from the neural network.

21. The apparatus of claim 20, wherein the coordinates are determined based on the bounding box.

22. The apparatus of claim 1, wherein the at least one processor is further configured to determine bird's-eye-view coordinates corresponding to the object-to-lane association points of the at least one lane of the one or more lanes of the road based on the coordinates.

23. The apparatus of claim 22, wherein the at least one processor is further configured to track the bird's-eye-view coordinates based on successive images.

24. The apparatus of claim 1, wherein the at least one processor is further configured to determine three-dimensional coordinates corresponding to the object-to-lane association points of the at least one lane of the one or more lanes of the road based on the coordinates.

25. The apparatus of claim 24, wherein the at least one processor is further configured to track the three-dimensional coordinates based on successive images.

26. The apparatus of claim 1, wherein the at least one processor is further configured to control a vehicle based on the coordinates.

27. The apparatus of claim 1, wherein the at least one processor is further configured to provide information to a driver of a vehicle based on the coordinates.

28. A method for determining lane information, the method comprising:
obtaining an image representative of one or more lanes of a road and an object, wherein the object is adjacent to the road; and
determining coordinates of object-to-lane association points of at least one lane of the one or more lanes of the road, wherein the coordinates are associated with the object.

29. The method of claim 28, wherein the coordinates comprise image coordinates.

30. The method of claim 28, wherein the coordinates comprise three-dimensional coordinates.
